(19) United States
(12) Patent Application Publication
(10) Pub. No.: US 2025/0084597 A1
(43) Pub. Date: Mar. 13, 2025

(54) COMMON-USE ROCKFALL PROTECTION AND AVALANCHE PREVENTION FENCE

(71) Applicant: Tokyo Rope MFG. CO., LTD., Tokyo (JP)

(72) Inventors: Kazuhiro KOSEKI, Hokkaido (JP); Masami IMAI, Hokkaido (JP)

(21) Appl. No.: 18/727,737

(22) PCT Filed: Mar. 4, 2022
(86) PCT No.: PCT/JP2022/009384

§ 371 Date: Jul. 10, 2024

(51) Int. Cl. E01F 7/04

(52) U.S. Cl. CPC E01F 7/045

(57) ABSTRACT

To provide a common-use rockfall protection and avalanche prevention fence which can efficiently absorb the energy of rockfalls and which is more suitable as a protection fence having both functions of rockfall protection and avalanche prevention.

A common-use rockfall protection and avalanche prevention fence includes terminal struts installed at both ends; a plane member fixed to the terminal struts and deployed between the terminal struts; an intermediate strut disposed between the terminal struts; and an attachment wire net for fixedly attaching the plane member to the intermediate strut, a breaking load of fixing of the attachment wire net being smaller than a breaking load of the plane member.

### TECHNICAL FIELD

This invention relates to a fence for common use as a rockfall protection fence and an avalanche prevention fence.

### BACKGROUND ART

In order to protect roads, buildings, etc. from rockfalls, etc. on sloping land, etc., protection fences (rockfall protection fence) are used which are installed on the slope side of the roads, buildings, etc. to be protected. A general rockfall protection fence has a structure in which an upper member formed of a strut, a wire rope, and a wire net is supported by a concrete foundation, thereby stopping rockfalls from the upper side of a slope to prevent disasters.

Such a rockfall protection fence is disclosed in Non-Patent Document 1.

Further, Patent Document 1 and Patent Document 2 disclose a technique related to a rockfall protection fence which is improved to widen the range of absorption capacity of the energy of rockfall.

### CITATION LIST

### Non Patent Literature

Non Patent Document 1: https://www.hkd.mlit.go.jp/ky/kn/dou_ken/ud49g700000023a8-att/splaat0000003yer.pdf

### Patent Literature

Patent Document 1: Japanese Patent Application Publication 2019-85691
Patent Document 2: Japanese Patent Application Publication 2019-85692

### SUMMARY OF INVENTION

### Technical Problem

In snowy areas, avalanche prevention is also necessary in addition to rockfall protection on sloping land, and from the viewpoint of economic efficiency, etc., both rockfall protection and avalanche prevention functions may be provided by a single protection fence. Protective facilities disclosed in Patent Documents 1 and 2 can also be used as rockfall protection fences and avalanche prevention fences.

An object of this invention is to provide a common-use rockfall protection and avalanche prevention fence which can efficiently absorb energy of rockfall and which is more suitable as a protection fence having both functions of rockfall protection and avalanche prevention.

### Solution to Problem

### (Configuration 1)

A common-use rockfall protection and avalanche prevention fence, including: terminal struts installed at both ends; a plane member fixed to the terminal struts and deployed between the terminal struts; an intermediate strut disposed between the terminal struts; and an attachment wire net for fixedly attaching the plane member to the intermediate strut, a breaking load of fixing of the attachment wire net being smaller than a breaking load of the plane member.

### (Configuration 2)

The common-use rockfall protection and avalanche prevention fence according to Configuration 1, in which when receiving a snow pressure due to accumulated snow, sliding of the plane member with respect to the intermediate strut is suppressed by the attachment wire net, and in which when receiving predetermined collision energy at a time of collision of a rockfall, fixing by the attachment wire net is broken, and the plane member is configured to slide with respect to the intermediate strut.

### (Configuration 3)

The common-use rockfall protection and avalanche prevention fence according to Configuration 1 or 2, in which a breaking load of the attachment wire net is smaller than the breaking load of the plane member.

### (Configuration 4)

The common-use rockfall protection and avalanche prevention fence according to Configuration 1 or 2, including an attachment member for attaching the attachment wire net to the plane member, in which a breaking load of the attachment member is smaller than the breaking load of the plane member.

### (Configuration 5)

The common-use rockfall protection and avalanche prevention fence according to Configuration 1 or 2, in which the breaking load of fixing of the attachment wire net is adjusted by an attachment range of the attachment wire net in an up-down direction.

### (Configuration 6)

The common-use rockfall protection and avalanche prevention fence according to any of Configurations 1 to 5, including a backup wire net attached to the plane member so that the plane member is slidable with respect to the intermediate strut by a predetermined length, a breaking load of the backup wire net being equal to or greater than the breaking load of the plane member.

### (Configuration 7)

The common-use rockfall protection and avalanche prevention fence according to Configuration 6, in which when receiving predetermined collision energy at a time of collision of a rockfall, fixing by the attachment wire net is broken, and the backup wire net is configured to slide the plane member by the predetermined distance.

### (Configuration 8)

The common-use rockfall protection and avalanche prevention fence according to Configuration 6 or 7, in which the common-use rockfall protection and avalanche prevention fence is provided on a slope or in a vicinity thereof, and the plane member is disposed on an upper side of the slope with respect to the intermediate strut, and in which the backup wire net is attached to the plane member to surround the intermediate strut from a lower side of the slope.

### Advantageous Effects of Invention

According to this invention, it is possible to provide a common-use rockfall protection and avalanche prevention fence which is more suitable as a protection fence having both functions of rockfall protection and avalanche prevention.

### BRIEF DESCRIPTION OF DRAWINGS

FIG. 1 is a front view illustrating an outline of a common-use rockfall protection and avalanche prevention fence of Embodiment 1 according to this invention.

FIG. 2 is an explanatory view (top view) illustrating an attachment wire net of the common-use rockfall protection and avalanche prevention fence of Embodiment 1.

FIG. 3 is an explanatory view illustrating a state in which the common-use rockfall protection and avalanche prevention fence of Embodiment 1 receives a rockfall.

FIG. 4 is an explanatory view illustrating a function of the attachment wire net when the common-use rockfall protection and avalanche prevention fence of Embodiment 1 receives accumulated snow.

FIG. 5 is a front view illustrating an outline of a common-use rockfall protection and avalanche prevention fence of Embodiment 2 according to this invention.

FIG. 6 is an explanatory view illustrating an attachment wire net and a backup wire net of the common-use rockfall protection and avalanche prevention fence of Embodiment 2.

FIG. 7 is an explanatory view illustrating a state in which the common-use rockfall protection and avalanche prevention fence of Embodiment 2 receives a rockfall.

FIG. 8 is an explanatory view illustrating a function of the common-use rockfall protection and avalanche prevention fence of Embodiment 2 when receiving accumulated snow.

FIG. 9 is an explanatory view illustrating an example of attachment of the attachment wire net and the backup wire net.

FIG. 10 is an explanatory view illustrating an example of attachment of the attachment wire net and the backup wire net.

### DESCRIPTION OF EMBODIMENTS

Embodiments of this invention will be specifically described below with reference to the drawings. Note that the embodiments described below are only modes when this invention is embodied, and this invention is not limited to a scope of the embodiments.

### Embodiment 1

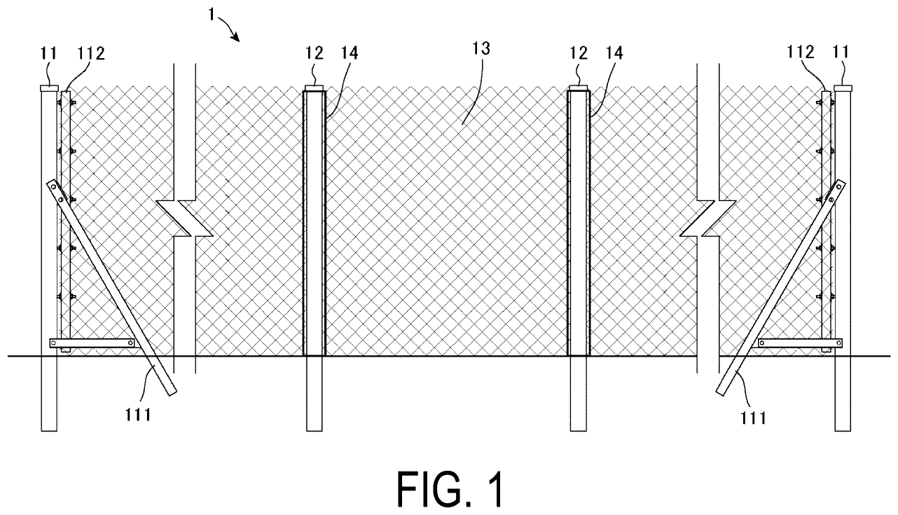

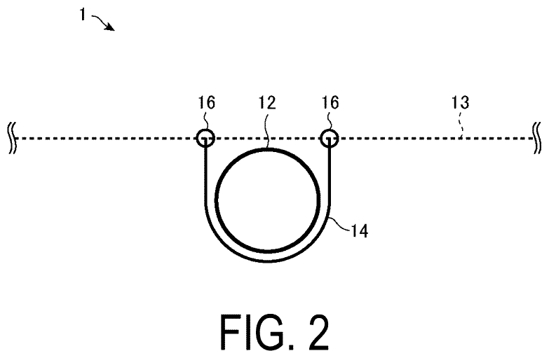

FIG. 1 is a front view (a view seen from a lower side of a slope) illustrating an outline of a common-use rockfall protection and avalanche prevention fence (hereinafter, simply referred to as a “common-use protection fence”) according to Embodiment 1. FIG. 2 is a schematic view illustrating the configuration of a common-use protection fence 1 at a position where an intermediate strut 12 is provided.

The common-use protection fence 1 of this embodiment functions as a rockfall protection fence that is installed on the slope side of roads, buildings, etc. for protecting the roads, buildings, etc. from rockfall, etc. on sloping land, etc. (slope or its vicinity), and also functions as an avalanche prevention fence for preventing an occurrence of avalanche.

The common-use protection fence 1 of this embodiment includes terminal struts 11 installed at both ends, a wire net 13 which is a plane member fixed to the terminal struts 11 and deployed between the terminal struts at both ends, the intermediate strut 12 disposed between the terminal struts 11, and an attachment wire net 14 for fixedly attaching the wire net 13 to the intermediate strut 12, a breaking load of fixing of the attachment wire net 14 being smaller than a breaking load of the plane member 13.

The terminal strut 11 is formed of, for example, an H-shaped steel, and supported by a concrete foundation. The terminal strut itself can be made of any strut having required strength, and its supporting configuration (foundation) can be of any of those (e.g., instead of a concrete foundation, a pile or an anchor bolt may be used to support the strut) that generate required supporting force.

In this embodiment, the terminal strut 11 is provided with a support member 111 and an attaching member 112 for securing the wire net 13.

The support member 111 is for resisting a force acting so that the terminal strut 11 falls inward due to the wire net 13 being pulled by an impact when receiving the rockfall. The support member 111 is not always necessary if the strength obtained by the terminal strut itself (and the foundation) is sufficient.

The attaching member 112 is a steel material bolted to a web of the terminal strut 11 which is H-shaped steel, and an end of the wire net 13 is fixed to the attaching member 112. In this embodiment, the wire net 13 is attached to the terminal strut 11 via the attaching member 112 in a laterally deployed manner (arrangement where the wire rows forming the wire net are vertical). The attaching member 112 may be of any configuration that allows the wire net to be secured to the terminal strut with the required strength, or the wire net may be directly secured to the terminal strut (without providing a separate attaching member).

The intermediate struts 12 of this embodiment are formed of steel tubes, and are arranged between the terminal struts 11 at predetermined intervals (e.g., every 1 m to 10 m). As illustrated in FIG. 2 (the upper side of FIG. 2 corresponds to the upper side of the slope, and the lower side corresponds to the lower side of the slope), the intermediate strut 12 is disposed on the lower side of the slope with respect to the wire net 13.

Similar to the terminal strut, the intermediate strut itself can be made of any strut having the required strength, and its supporting configuration (foundation) can be of any of those (for example, instead of a concrete foundation, a pile or an anchor bolt may be used to support the strut) that generate required supporting force. The number of intermediate struts is determined in accordance with the overall width of the common-use protection fence 1 and the span (interval between struts).

As illustrated in FIGS. 1 and 2, the attachment wire net 14 is attached to the wire net 13 so as to surround the intermediate strut 12 from the lower side of the slope. The attachment is performed by an attachment member 16 for attaching the attachment wire net 14 to the wire net 13. As an example of the attachment by the attachment member 16, for example, the attachment wire net 14 and the wire net 13 are fastened so as to be wound by using a coupling coil, the attachment wire net 14 and the wire net 13 are fastened so as to be woven by a wire row of the wire net, etc., but is not limited thereto, and any method that can fasten the attachment wire net and the plane member with the necessary strength can be used.

As will be described below, the attachment wire net 14 is for suppressing sliding of the wire net 13 with respect to the intermediate strut 12 when receiving snow pressure due to accumulated snow. Therefore, the attachment wire net 14 is attached so as to fix the wire net 13 to the intermediate strut 12 (so as to prevent the wire net 13 from being displaced with respect to the intermediate strut 12 in the deploying direction of the fence (the left-right direction in FIGS. 1 and 2)).

Further, in the attachment wire net 14 of this embodiment, the tensile strength of the wire row constituting the wire net is lower than the tensile strength of the wire row of the wire net 13, and therefore, the breaking load of the attachment wire net 14 is smaller than the breaking load of the wire net 13. Thus, when receiving predetermined collision energy at the time of collision of a rockfall, the attachment wire net 14 is broken, and the wire net 13 slides to the intermediate strut 12. The attachment member 16 has such a strength that the breaking load of the attachment portion by the attachment member 16 is at least greater than the breaking load of the attachment wire net 14.

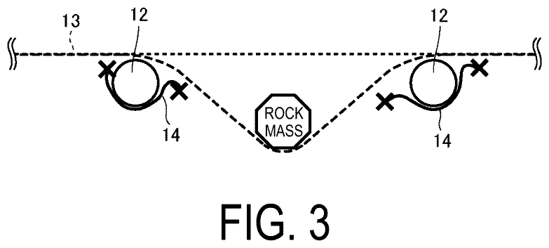

FIG. 3 is a schematic plan view illustrating a state in which the common-use protection fence 1 receives the rockfall.

As described above, since the attachment wire net 14 is configured to be broken when receiving the predetermined collision energy at the time of the collision of the rockfall, when the wire net 13 receives the rockfall, the fixing of the wire net 13 to the intermediate strut by the attachment wire net 14 is broken, and the wire net 13 can slide with respect to the intermediate strut 12.

Namely, the impact energy of rockfall propagates efficiently over the entire length of the wire net 13, and the impact energy can be absorbed over the entire length of the wire net 13 (depending on the collision energy, the energy does not always propagate over the entire length of the wire net). When the wire net is subjected to impact energy of rockfall, elongation occurs due to structural deformation (deformation of meshing, etc.), elongation of element wires themselves forming the wire net, etc. Energy is consumed by plastic deformation, friction between members, etc. that occur at this circumstance, which absorbs the collision energy, and this effect can be generated over the entire length in the width direction of the wire net.

A conventional protection fence is configured such that a wire net is usually fixed directly or indirectly to an intermediate strut, and there is no concept of intentionally breaking the fixing in a conventional protection fence, thus collision energy is concentrated only in a specific span hit by a rockfall. Therefore, strength sufficient to withstand the collision energy is required for each member. However, according to the common-use protection fence 1 of this embodiment, an excellent effect can be obtained where energy can be absorbed (energy is dispersed) with the entire fence, enabling reduction of the spec of each member.

In addition to such an effect that “the energy is absorbed by the entire fence”, when the attachment wire net 14 is broken, the energy is also absorbed by the attachment wire net 14 and the attachment member 16, so that higher energy absorption capacity can be obtained. The setting of the breaking load of the attachment wire net 14 (i.e., the setting of the “predetermined collision energy at the time of collision of a rockfall”) is appropriately determined on the basis of the design concept and specifications of each common-use protection fence. When there is a rockfall which does not satisfy “predetermined collision energy”, the attachment wire net 14 is not broken, and the rockfall is received by the common-use protection fence 1.

On the other hand, in the case where the common-use protection fence 1 is used as an avalanche prevention fence to retain accumulated snow, if the wire net 13 freely slides, inconvenience may occur.

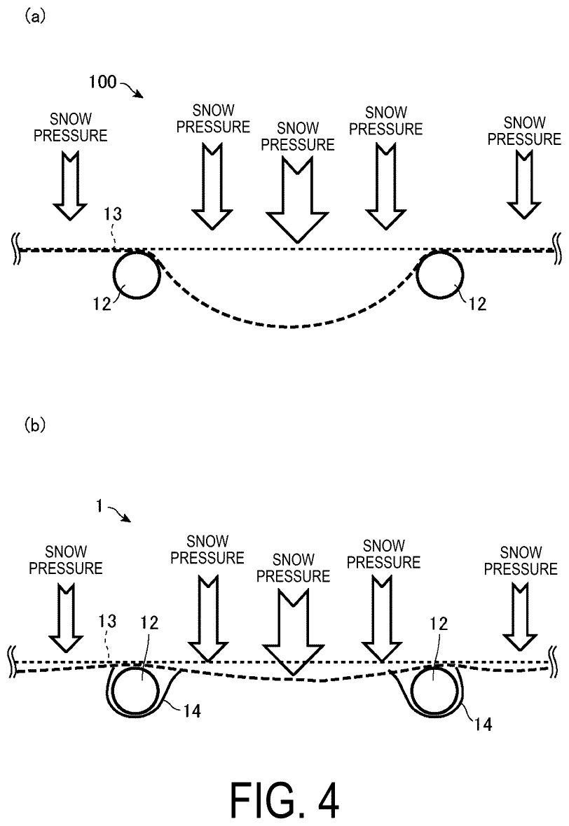

Accumulated snow in a natural environment is not always uniform due to the influence of topography, etc. For example, snow accumulation may increase locally due to snowdrifts. When such an irregularity occurs, a load is applied only to a specific span as compared with the other spans at the initial stage of snowfall, and the wire net may be largely deflected in the relevant span as conceptually illustrated in FIG. 4A. With further progression of the snowfall, further snow load is applied to the span which has been largely deflected in advance, which may lead to breakage of the member.

With respect to such a problem, in the common-use protection fence 1 of this embodiment, as can be understood from FIG. 4B, since the wire net 13 is fixed to the intermediate strut 12 by the attachment wire net 14, it is possible to reduce the large deflection of the wire net 13 in the specific span due to the irregularity of the accumulated snow. As a result, the wire net 13 has a function of equalizing the deflection in each span.

As described above, according to the common-use protection fence 1 of this embodiment, since the energy of rockfall can be efficiently absorbed and the wire net can be prevented from being largely deflected in a specific span even in an environment with irregular snow accumulation, it is possible to provide a common-use rockfall protection and avalanche prevention fence which is more suitable as a protection fence having both functions of rockfall protection and avalanche prevention.

In addition, since the number of components is relatively small and it contains inexpensive parts such as wire net, it is possible to provide the common-use rockfall protection and avalanche prevention fence at a low cost.

### Embodiment 2

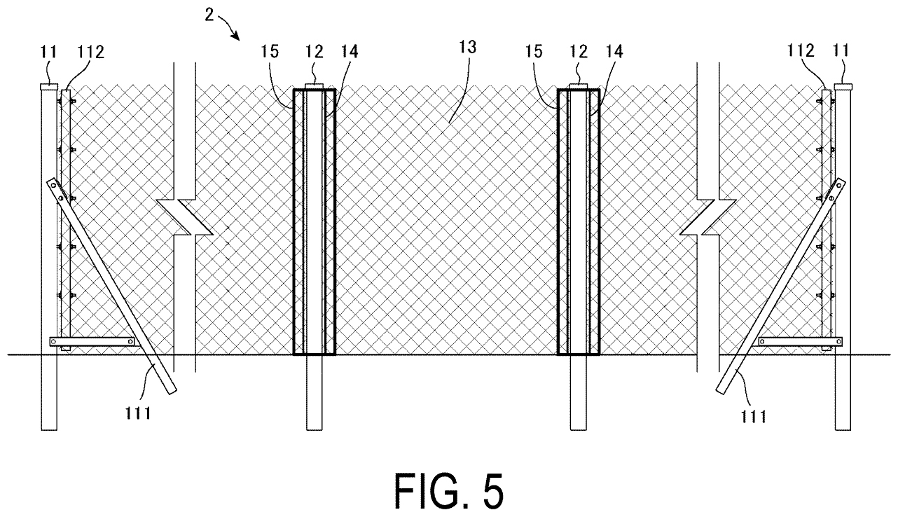

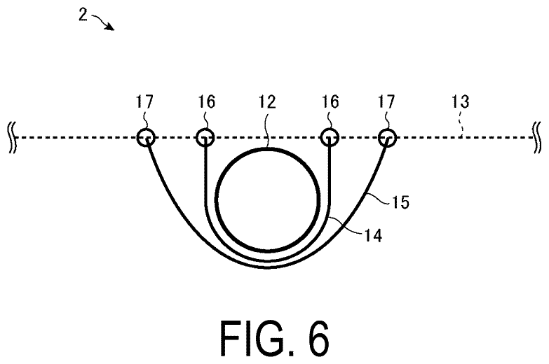

FIG. 5 is a front view (a view seen from the lower side of the slope) illustrating an outline of a common-use protection fence 2 according to Embodiment 2. FIG. 6 is a schematic view illustrating the configuration of the common-use protection fence 2 at a position where the intermediate strut 12 is provided.

Note that the same components as those of the common-use protection fence 1 of Embodiment 1 are denoted by the same reference numerals, and the description thereof will be omitted or simplified.

The common-use protection fence 2 of this embodiment is different from the common-use protection fence 1 of Embodiment 1 in that the common-use protection fence 2 includes a backup wire net 15.

In the backup wire net 15, the tensile strength of the wire row constituting the wire net is equal to or greater than the tensile strength of the wire row of the wire net 13, and therefore, the breaking load of the backup wire net 15 is equal to or greater than the breaking load of the wire net 13 (in this embodiment, the same wire net is used for the backup wire net 15 and the wire net 13).

As can be understood from FIG. 6 (the upper side in FIG. 6 corresponds to the upper side of the slope, and the lower side corresponds to the lower side of the slope), the backup wire net 15 is attached to the wire net 13 so as to surround the intermediate strut 12 from the lower side of the slope. In addition, the backup wire net 15 is attached to the wire net 13 with an extra length so that the wire net 13 can slide by a predetermined distance with respect to the intermediate strut 12 (can slide in the deploying direction of the fence (the left-right direction in FIGS. 5 and 6)). The breaking load of the attachment portion is constituted so as to be equal to or greater than the breaking load of the backup wire net 15.

The attachment of the backup wire net 15 to the wire net 13 can be performed by using any method that can fasten the backup wire net and the plane member with the necessary strength, in addition to the attachment by an attachment member 17 such as the coupling coil or the wire row, similarly to the attachment method of the attachment wire net 14 of Embodiment 1.

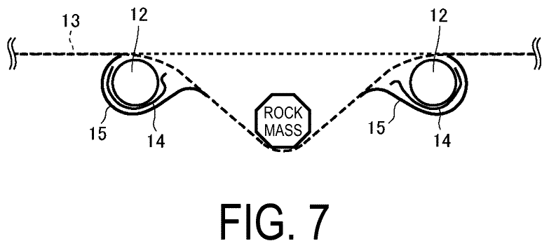

FIG. 7 is a schematic plan view illustrating a state in which the common-use protection fence 2 of this embodiment receives a rockfall.

As described in Embodiment 1, since the attachment wire net 14 is configured to be broken when receiving the predetermined collision energy at the time of the collision of the rockfall, the fixing of the wire net 13 to the intermediate strut by the attachment wire net 14 is broken when the wire net 13 receives the rockfall.

On the other hand, the backup wire net 15 has the same strength as the wire net 13 and is not broken by the collision energy within the range of the specification of the fence, but as described above, the backup wire net 15 is attached so that the wire net 13 can slide by a predetermined distance with respect to the intermediate strut 12, and therefore, the wire net 13 for receiving the rockfall slides. That is, “when receiving predetermined collision energy at the time of collision of a rockfall, the fixing by the attachment wire net is broken, and the backup wire net is configured to slide the plane member by a predetermined distance”.

Accordingly, it is possible to obtain the same effect as that of Embodiment 1 (for example, an effect of “the energy is absorbed by the entire fence”, etc.).

Furthermore, according to the common-use protection fence 2 of this embodiment, since the backup wire net 15 is provided, it is also possible to obtain an effect that the rockfall can be captured more reliably. For example, when a rockfall directly hits the intermediate strut 12, the wire net 13 may break by being sandwiched between the rockfall and the intermediate strut 12 (broken not by tension but by shear). Even in such a case, since the backup wire net 15 having a strength equal to or greater than a strength of the wire net 13 is connected in parallel, the rockfall can be more reliably captured.

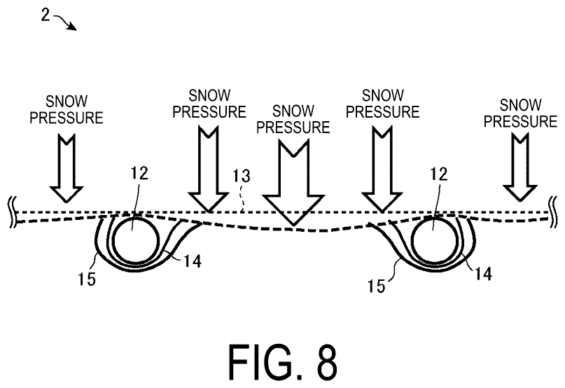

FIG. 8 is an explanatory view illustrating a function of the common-use protection fence 2 of this embodiment when receiving accumulated snow.

Similarly to Embodiment 1, since the wire net 13 is fixed to the intermediate strut 12 by the attachment wire net 14, the wire net 13 is prevented from being largely deflected in the specific span due to the irregularity of the accumulated snow, and the deflection of the wire net 13 in each span is equalized.

As described above, according to the common-use protection fence 2 of this embodiment, the same operation and effect as those of Embodiment 1 can be obtained, and since the backup wire net 15 is provided, it is possible to obtain an effect that the rockfall can be captured more reliably.

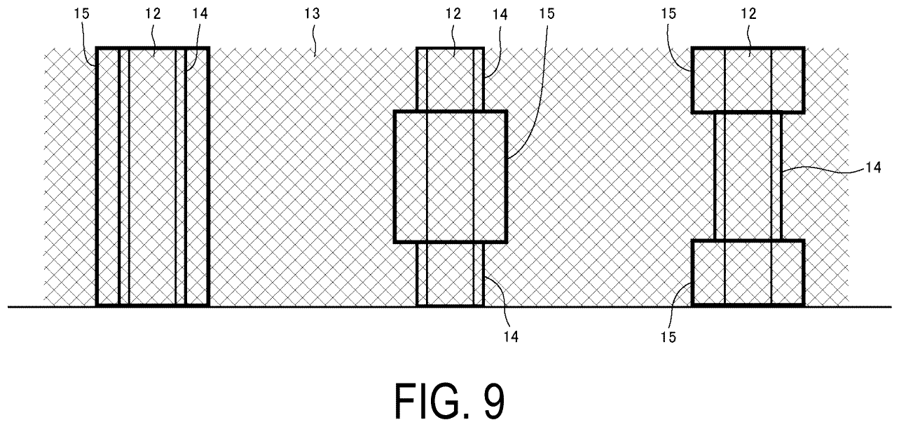

In the embodiments, as illustrated on the left side of FIG. 9, the attachment wire net 14 and the backup wire net 15 are provided in the same height range as the strut 12 (or the wire net 13), but this invention is not limited thereto. For example, as illustrated in the center of FIG. 9 (the attachment wire net is provided in two upper and lower stages and the backup wire net is provided in the center) and the right side (the attachment wire net is provided in the center and the backup wire net is provided in two upper and lower stages), each can be installed in any height range, and can be separately provided in a plurality of places such as two upper and lower stages. Such a change in the attachment range or position is also effective in a case where local accumulated snow is expected, for example, in a case where the struts cannot be arranged in a straight line in a planar manner, in a case where there is a vertical step or the like, or in a condition where there is a possibility that a difference in accumulated snow occurs due to topography or a slope gradient.

In the embodiments, the tensile strength of the wire row constituting the attachment wire net 14 is made lower than the tensile strength of the wire row of the wire net 13, whereby the breaking load of the attachment wire net 14 is made smaller than the breaking load of the wire net 13. However, this invention is not limited to this.

As another method for making the breaking load of the attachment wire net 14 smaller than the breaking load of the wire net 13, for example, the configuration of the wire mesh of the wire net may be changed (the mesh of the attachment wire net 14 may be larger than that of the wire net 13, or the wire diameter of the attachment wire net 14 may be smaller (thinner) than that of the wire net 13), or the attachment range of the wire net in the up-down direction may be changed (changed as illustrated in FIG. 9). According to the method of changing the attachment range of the attachment wire net 14 (reducing the size of the attachment wire net 14) as illustrated in FIG. 9, it is possible to “make the breaking load of the attachment wire net smaller than the breaking load of the wire net” while using a common wire net, and thus it is possible to achieve commonality of members.

Further, in the embodiments, by making the breaking load of the attachment wire net 14 smaller than the breaking load of the wire net 13, the fixing by the attachment wire net is broken when the “predetermined collision energy” is received. However, this invention is not limited to this.

For example, the breaking load of the attachment portion of the attachment member 16 constituted by a coupling coil or the like may be made smaller than the breaking load of the wire net 13. That is, a configuration may be adopted in which “the fixing by the attachment wire net is broken” by breaking the attachment portion when “predetermined collision energy” is received.

The breaking load of the attachment portion of the attachment member 16 may be set by selecting the material, etc. of the attachment member 16 such as the coupling coil, or the breaking load may be adjusted by, for example, the attachment length, the number of turns, etc. of the coupling coil similarly to the description of the attachment range of the attachment wire net 14 in FIG. 9.

In the embodiments, the end portions of the attachment wire net 14 and the backup wire net 15 are fastened to the wire net 13 at different positions. However, this invention is not limited thereto.

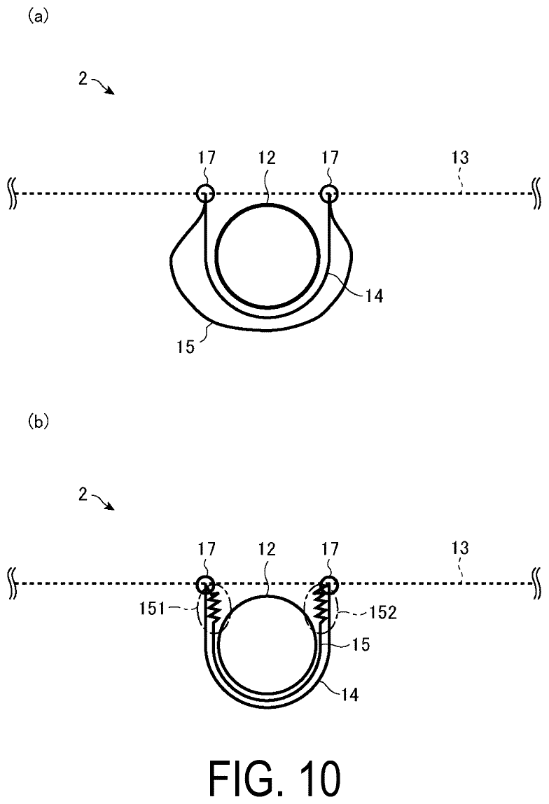

For example, as illustrated in FIG. 10A, the end portions of the attachment wire net 14 and the backup wire net 15 may be attached to the wire net 13 at the same position (only one end portion may be attached at the same position instead of both end portions). In this case, the attachment wire net 14 and the backup wire net 15 may be attached to the wire net 13 by the same attachment member 17 (coupling coil or the like).

In the embodiments, the backup wire net 15 is attached to the outside of the attachment wire net 14, but this invention is not limited thereto.

For example, as illustrated in FIG. 10B, the backup wire net 15 may be attached to the inner side of the attachment wire net 14. Also in this case, the backup wire net 15 can be attached to the wire net 13 with an extra length. In this case, the backup wire net 15 may be formed into a “plain weave” in which both end portions of the wire net are “left as cut” so that the excess length portion of the backup wire net 15 is well fitted. When both ends of the wire net are “left as cut” so that the element wires (wire rows) are not fastened to each other, the element wires (wire rows) are released from each other, and thus the element wires (wire rows) can be folded so as to slide with respect to each other (a folding portion 151, 152 in FIG. 10B). In this manner, it is possible to install the backup wire net 15 with an extra length and then attach the attachment wire net 14 from the outside of the backup wire net 15 so as to suppress the sliding of the wire net 13 with respect to the intermediate strut 12.

The length of the extra length when the backup wire net is attached to the wire net is appropriately determined based on the specification, the design concept, etc. of the fence, but the length may be changed according to the position with respect to the terminal strut.

The sliding amount of the wire net at the time of a rockfall collision tends to be larger at a location away from the terminal strut (closer to the center of the fence) than in the vicinity of the terminal strut (a location where the wire net is fixed). Therefore, by increasing the extra length provided in the backup wire net as the distance from the terminal strut increases, the effect of “the energy is absorbed by the entire fence” described above can be more efficiently obtained.

It is not necessary to provide the attachment wire net and the backup wire net for all of the intermediate struts. For example, the attachment wire net may not be provided to the intermediate strut close to the terminal strut, or the attachment wire net may be provided to the intermediate strut at a predetermined interval or every predetermined number. Further, in the installation environment of the common-use protection fence, when a place where snow accumulation is large is known in advance, the attachment wire net may be provided only for the intermediate strut installed in the vicinity thereof.

Depending on the specifications of the rockfall protection fence and the avalanche prevention fence, any wire net that can meet the specifications can be used as the wire net 13 (in consideration of the function as the rockfall protection fence, for example, a high-strength wire net having a 1000 N/mm² or more is preferably used). The energy absorbing plane member and the energy absorbing device disclosed in Patent Document 1 and Patent Document 2 can also be used. If necessary, a reinforcing member for reinforcing an upper portion or a lower portion of the plane member may be provided. On the other hand, as the attachment wire net, for example, an ordinary wire net of about 400 N/mm² can be used.

In the embodiments, while an example is given where the wire net 13 is attached to the terminal strut 11 in a laterally deployed manner (arrangement where the wire rows forming the wire net are vertical), the wire net may be vertically deployed (arrangement where the wire rows are horizontal).

### REFERENCE SIGNS LIST

1 . . . common-use rockfall protection and avalanche prevention fence
11 . . . terminal strut
12 . . . intermediate strut
13 . . . wire net (plane member)
14 . . . attachment wire net
15 . . . backup wire net
16, 17 . . . attachment member

What is claimed is:

1. A common-use rockfall protection and avalanche prevention fence, comprising:
terminal struts installed at both ends;
a plane member fixed to the terminal struts and deployed between the terminal struts;
an intermediate strut disposed between the terminal struts; and
an attachment wire net for fixedly attaching the plane member to the intermediate strut, a breaking load of fixing of the attachment wire net being smaller than a breaking load of the plane member.

2. The common-use rockfall protection and avalanche prevention fence according to claim 1, wherein when receiving a snow pressure due to accumulated snow, sliding of the plane member with respect to the intermediate strut is suppressed by the attachment wire net, and wherein when receiving predetermined collision energy at a time of collision of a rockfall, fixing by the attachment wire net is broken, and the plane member is configured to slide with respect to the intermediate strut.

3. The common-use rockfall protection and avalanche prevention fence according to claim 1, wherein a breaking load of the attachment wire net is smaller than the breaking load of the plane member.

4. The common-use rockfall protection and avalanche prevention fence according to claim 1, comprising an attachment member for attaching the attachment wire net to the plane member, wherein
a breaking load of the attachment member is smaller than the breaking load of the plane member.

5. The common-use rockfall protection and avalanche prevention fence according to claim 1, wherein the breaking load of fixing of the attachment wire net is adjusted by an attachment range of the attachment wire net in an up-down direction.

6. The common-use rockfall protection and avalanche prevention fence according to any of claim 1, comprising a backup wire net attached to the plane member so that the plane member is slidable with respect to the intermediate strut by a predetermined length, a breaking load of the backup wire net being equal to or greater than the breaking load of the plane member.

7. The common-use rockfall protection and avalanche prevention fence according to claim 6, wherein when receiving predetermined collision energy at a time of collision of a rockfall, fixing by the attachment wire net is broken, and the backup wire net is configured to slide the plane member by the predetermined distance.

8. The common-use rockfall protection and avalanche prevention fence according to claim 6, wherein the common-use rockfall protection and avalanche prevention fence is provided on a slope or in a vicinity thereof, and the plane member is disposed on an upper side of the slope with respect to the intermediate strut, and wherein the backup wire net is attached to the plane member to surround the intermediate strut from a lower side of the slope.
